(19) United States
(12) Patent Application Publication
(10) Pub. No.: US 2009/0098448 A1
(43) Pub. Date: Apr. 16, 2009

(54) COMPOSITE NEGATIVE ELECTRODE ACTIVE MATERIAL FOR NON-AQUEOUS ELECTROLYTE SECONDARY BATTERY AND METHOD FOR PREPARING THE SAME, AND NON-AQUEOUS ELECTROLYTE SECONDARY BATTERY INCLUDING THE SAME

(76) Inventors: Yoshiyuki Ozaki, Osaka (JP); Hiroyuki Fujimoto, Nara (JP)

Correspondence Address: MCDERMOTT WILL & EMERY LLP, 600 13TH STREET, NW, WASHINGTON, DC, 20005-3096, US

(21) Appl. No.: 12/297,381

(22) PCT Filed: Oct. 16, 2007
(86) PCT No.: PCT/JP2007/070115

§ 371 Date: Oct. 16, 2008

(30) Foreign Application Priority Data
Oct. 16, 2006 (JP) 2006 281202

(51) Int. Cl. H01M 4/58; H01M 2/14; H01M 4/04; H01M 10/36

(52) U.S. Cl. 429/129; 429/231.8; 29/623.5

(57) ABSTRACT

The present invention can provide a composite negative electrode active material including a fused matter of a graphite material and a graphitizable carbon material undergoing graphitization. Such a composite negative electrode active material is prepared by heating a mixture of a graphite material and a graphitizable carbon material undergoing graphitization at 700° C. to 1300° C., and crushing the obtained fused matter. The use of the composite negative electrode active material makes it possible to provide a non-aqueous electrolyte secondary battery being excellent in output-input characteristics and having a high energy density and a long life.

### RELATED APPLICATIONS

This application is the U.S. National Phase under 35 U.S.C. § 371 of International Application No. PCT/JP2007/070115, filed on Oct. 16, 2007, which in turn claims the benefit of Japanese Application No. 2006-281202, filed on Oct. 16, 2006, the disclosures of which Applications are incorporated by reference herein.

### TECHNICAL FIELD

The present invention relates to a composite negative electrode active material for a non-aqueous electrolyte secondary battery and particularly to a negative electrode active material for a lithium ion secondary battery having a high capacity and being excellent in output-input characteristics and life characteristics.

### BACKGROUND ART

Lithium ion secondary batteries are secondary batteries with high operating voltage and high energy density. For this reason, in recent years, such lithium ion secondary batteries have been put into practical use as a driving power source for portable electronic equipment such as mobile phones, notebook computers, and video camcorders, and the use thereof has been rapidly grown. Moreover, the production volume of lithium ion secondary batteries as a leading battery system in the field of small-size secondary batteries has been increasing.

For positive electrode active materials of lithium ion secondary batteries, for example, lithium-containing composite oxides with high voltage of 4 V class are used. Typical examples of such positive electrode active materials include LiCoO₂ and LiNiO₂ having a hexagonal structure, and LiMn₂O₄ having a spinel structure. Among these, LiCoO₂ capable of providing high operating voltage and high energy density is predominantly used.

For negative electrode active materials, carbon materials capable of absorbing and desorbing lithium ions are used. Among these, graphite materials are predominantly used as the negative electrode active materials because of their flat discharge potentials and high energy densities.

Recently, not only for use in small-size household appliances but also for use in power storage apparatuses, electric vehicles, and the like, the development of large-size lithium ion secondary batteries with high capacity have been accelerated. For example, as a solution to environmental problems, hybrid electric vehicles (HEVs) with nickel metal hydride batteries mounted thereon have made commercially available on a mass production basis. As a power source to replace the nickel metal hydride batteries, lithium ion secondary batteries for use in HEVs also have been developed at a rapid pace, and partly put into practical use.

In addition, in light of the expected proliferation of fuel cell-powered vehicles in the future, lithium ion secondary batteries are considered to be promising as a power source with excellent output-input characteristics and long life that can assist the fuel cell.

The performances required for lithium ion secondary batteries for use in HEVs or fuel cell-powered vehicles are greatly different from those for lithium ion secondary batteries for use in small-size household appliances. In other words, the batteries for use in HEVs or fuel cell-powered vehicles are required to instantaneously provide power-assist to the engine or regenerate energy with limited capacity, and are expected to have a considerably higher output. Accordingly, in these batteries, the priority is placed on the achievement of a higher output-input density rather than the achievement of a higher energy density. In order to achieve this, it is necessary to reduce the internal resistance of the batteries to a smallest possible value. It has been attempted to provide a further improved output not only by developing and selecting an active material, a non-aqueous electrolyte, and the like, but also by, for example, reevaluating the current collecting structures of electrodes in order to reduce the resistance of component parts of the batteries, using a strip-like and thin electrode in order to increase the reaction area of the electrode, and other means.

In designing a high output type lithium ion secondary battery, the structure of electrodes and the reduction of the resistance of battery component parts act as major factors. However, particularly in a low temperature environment, effects achieved by selecting and/or improving an electrode active material cannot be ignored. Above all, carbon materials to be used as a negative electrode active material are greatly different from type to type in terms of the capability of absorbing and desorbing lithium. This means that a high output type battery can be provided by selecting a carbon material having an excellent capability of absorbing and desorbing lithium as a negative electrode active material.

In view of the above, a combination of a positive electrode active material including LiCoO₂ and a negative electrode active material including a graphite material as generally used in small-size household appliances is not always predominant in high output type lithium ion secondary batteries. In particular, with respect to carbon materials for negative electrodes, since the importance is placed on the high output-input characteristics rather than the capacity density, it has been considered preferable to use carbon materials, for example, a non-graphitizable carbon material or a graphitizable carbon material undergoing graphitization rather than graphite materials with high crystallinity. However, the capacity densities of such carbon materials are small.

The batteries for use in HEVs or fuel cell-powered vehicles are expected to have a high output as well as a high capacity. For example, so-called plug-in HEVs, which run for a certain distance exclusively with a fully battery-powered electric motor and, after the battery capacity is reduced below a predetermined value, run in an HEV mode in which the electric motor and the gasoline engine operate in combination, are under development by way of improving the capacity of the above-described batteries for use in HEVs. Lithium ion secondary batteries are highly expected as a promising driving power source for use in such applications.

Driving power sources for power tools are required to have a high output as well as an energy density equivalent to those of driving power sources for use in small household appliances. In order to satisfy such a requirement, attempts have been made for improving the capability of charging and discharging lithium by way of modifying the surface of graphite materials with high energy density. For example, Patent Document 1 suggests a multi-layer structure carbon material prepared by coating the surface of a graphite material as a core with a carbon precursor and carbonizing the carbon precursor to form it into a coating layer. Patent Document 2 suggests a double-layer carbon material with no crushed face, the double-layer carbon material prepared by coating a carbon material serving as a core material with a carbon material for forming a coating layer. Patent Document 3 suggests a carbon material mixture of graphite and a graphitizable carbon material undergoing graphitization.

However, in each particle of these carbon materials of multi-layer structure in which the surface of a graphite material is coated with a coating layer made of a carbon material different from the graphite material, it is difficult to uniformly control the amount of the coating layer. Moreover, since the coating layer is very thin, in the carbon materials of multi-layer structure, each particle is mainly composed of graphite component being the core. This means that these carbon materials of multi-layer structure are analogous to graphite in terms of the structure. Therefore, these carbon materials of multi-layer structure have a high capacity density, but the output-input characteristics cannot be improved beyond a certain limit. Further, in the mixture of graphite and a carbon material undergoing graphitization, depending on the mixed ratio of the graphite and the carbon material, the obtained characteristics are greatly different. For this reason, high output-input characteristics and a high capacity density cannot be simultaneously achieved beyond a certain limit.

Patent Document 1: Japanese Laid-Open Patent Publication No. Hei 11-54123 (Japanese Patent Publication No. 3193342)
Patent Document 2: Japanese Laid-Open Patent Publication No. Hei 11-310405 (Japanese Patent Publication No. 2976299)

### Patent Document 3: Japanese Laid-Open Patent Publication No. 2005-32593

### DISCLOSURE OF THE INVENTION

### Problem to be Solved by the Invention

In conventional non-aqueous electrolyte secondary batteries including a negative electrode active material mainly composed of a graphite material, it is possible to improve the energy density, but the output-input characteristics remain low. Non-aqueous electrolyte secondary batteries including a negative electrode active material mainly composed of a carbon material undergoing graphitization are excellent in output-input characteristics, but disadvantageous in improving the energy density of the batteries because of the low capacity density of the carbon material. Moreover, in the case where a mixture of two kinds of carbon materials is used as the negative electrode active material or in the case where a graphite particle in which the surface of the graphite particle is coated with a low crystalline carbon material is used as the negative electrode active material as disclosed in Patent Documents 1 to 3, the effects are small.

For the reasons above, with the conventional carbon materials, it is difficult to constitute a battery being excellent in durability to pulse charge at a high current as well as to pulse discharge at a high current and having a long life and a high energy density.

The present invention has been made in view of the problems as described above, the purpose of which is to provide a negative electrode active material for a non-aqueous electrolyte secondary battery being excellent in output-input characteristics and having a high capacity density and a long life and a method for preparing the same, and a non-aqueous electrolyte secondary battery including the negative electrode active material.

### Means for Solving the Problem

The present invention relates to a composite negative electrode active material for a non-aqueous electrolyte secondary battery including a fused matter of a graphite material and a graphitizable carbon material undergoing graphitization. It is preferably that the fused matter is coated with an amorphous carbon material. It is preferable that the ratio of the graphite material to a total of the graphite material and the graphitizable carbon material undergoing graphitization is 60% by mass to 90% by mass.

Further, the present invention relates to a method for preparing a composite negative electrode active material for a non-aqueous electrolyte secondary battery including the steps of:

(a) mixing a graphite material and a graphitizable carbon material undergoing graphitization to give a mixed carbon material;

(b) heating the mixed carbon material at 700° C. to 1300° C. to give a fused matter of the graphite material and the carbon material undergoing graphitization; and

(c) crushing the fused matter.

It is preferable that the graphitizable carbon material undergoing graphitization is obtained by heating a graphitizable carbon material at 1400° C. to 2200° C.

It is preferable that the step (a) further includes a step of adding a heavy oil to the mixed carbon material.

It is preferable that in the mixed carbon material, the ratio of the graphite material to a total of the graphite material and the graphitizable carbon material undergoing graphitization is 60% by mass to 90% by mass.

Furthermore, the present invention relates to a non-aqueous electrolyte secondary battery including a negative electrode including the foregoing composite negative electrode active material, a positive electrode, a non-aqueous electrolyte, and a separator interposed between the positive electrode and the negative electrode.

### EFFECT OF THE INVENTION

In the present invention, a graphite material that has a high capacity and a graphitizable carbon material undergoing graphitization that is excellent in output-input characteristics and life characteristics are fused together. As such, the characteristics of the graphite material and those of the graphitizable carbon material undergoing graphitization can be synergistically exerted. Therefore, the composite negative electrode active material of the present invention has a high capacity and is excellent in high output-input characteristics and life characteristics.

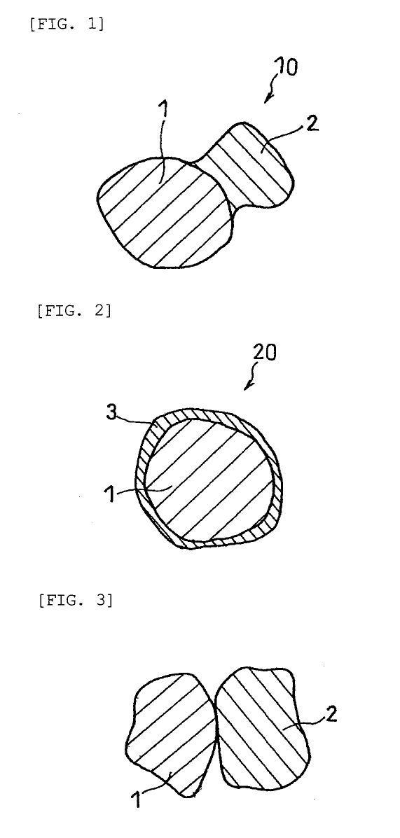

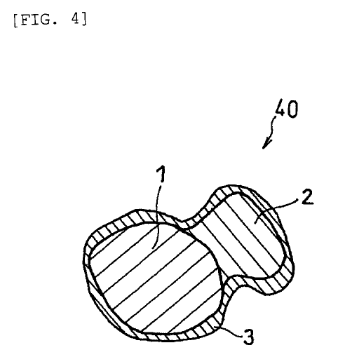

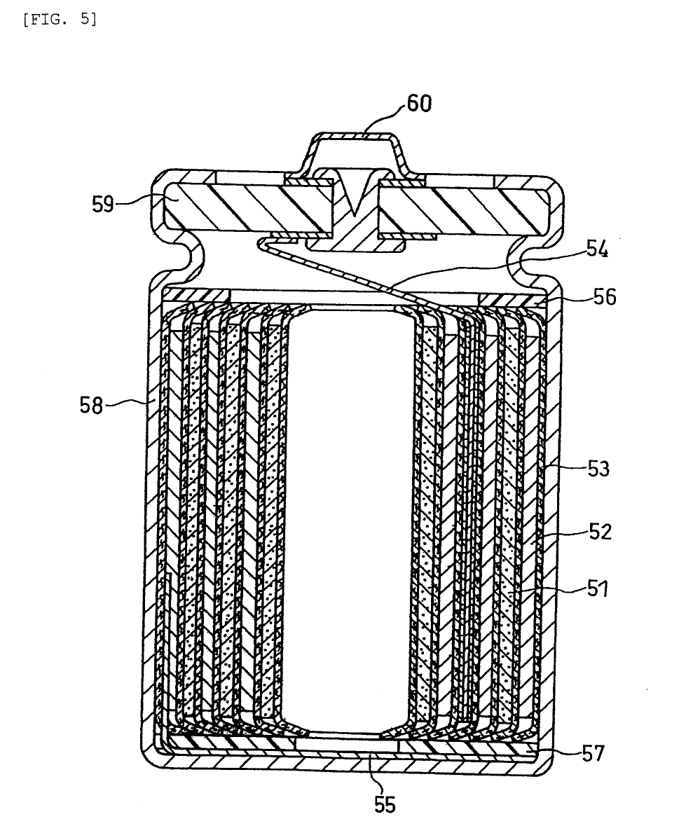

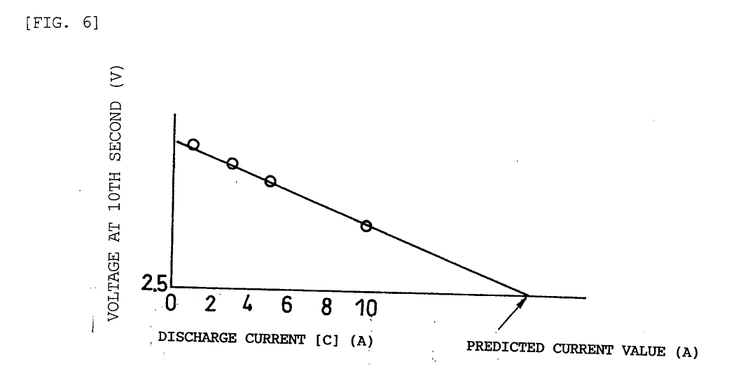

### BRIEF DESCRIPTION OF THE DRAWINGS

[FIG. 1] A schematic cross-sectional view illustrating a composite negative electrode active material according to one embodiment of the present invention.

[FIG. 2] A schematic cross-sectional view illustrating a conventional carbon material of multi-layer structure.

[FIG. 3] A schematic cross-sectional view illustrating a conventional negative electrode active material including a mixture of a graphite material and a graphitizable carbon material undergoing graphitization.

[FIG. 4] A schematic cross-sectional view illustrating a composite negative electrode active material according to another embodiment of the present invention.

[FIG. 5] A schematic longitudinal cross-sectional view illustrating a non-aqueous electrolyte secondary battery according to one embodiment of the present invention.

[FIG. 6] A diagram explaining a method of calculating output values from current-voltage characteristic test results.

### BEST MODE FOR CARRYING OUT THE INVENTION

The present invention is described below with reference to the drawings.

FIG. 1 illustrates a composite negative electrode active material according to one embodiment of the present invention. A composite negative electrode active material 10 in FIG. 1 includes a fused matter of a graphite material 1 and a graphitizable carbon material undergoing graphitization (hereinafter referred to as a second carbon material) 2. In other words, the composite negative electrode active material 10 of the present invention is a composite carbon material obtained by sintering two carbon materials differing from each other in the degrees of graphitization.

In the second carbon material 2, because of its turbostratic structure, the stress due to expansion and contraction in volume that occur as the intercalation and deintercalation of lithium proceed and the stress due to a phase change in the in-plane location are relieved than in the graphite material. This leads to a feature that excellent performance is maintained over a long period of time in pulse charge-discharge at a higher current. Therefore, the second carbon material 2 has properties such as high output and input and long life. In a non-graphitizable carbon material, which is a carbon material having an extreme type of turbostratic structure, stress is not produced by the expansion and contraction that occur as the absorption and desorption of lithium proceed. However, in the non-graphitizable carbon material, the charge-discharge reaction does not follow a charge-discharge mechanism through intercalation reaction of lithium between layers, but follows a complicated mechanism such as accommodation of lithium into the voids and/or adsorption of lithium to the portions of turbostratic structure. Therefore, there is a limit in the improvement of the performance in pulse charge-discharge at a high current. Moreover, the non-graphitizable carbon material has a large irreversible capacity density, failing to provide a high battery capacity.

On the other, since the capacity density of the second carbon material 2 is as small as approximately 70 Ah/kg to 280 Ah/kg, when the second carbon material 2 is used alone, it is difficult to improve the capacity of the battery. In the present invention, therefore, the graphite material 1 with high capacity and the second carbon material 2 excellent in output-input characteristics and life characteristics are fused together in order to obtain a negative electrode carbon material having a high capacity density, excellent output-input characteristics, and a long life.

In at least part of the joint face between the graphite material 1 and the second carbon material 2, the graphite material 1 and the second carbon material 2 are presumably present in a mixed state, and no grain boundaries are present.

In a carbon material 20 of multi-layer structure as shown in FIG. 2 in which the surface of the graphite material particle 1 is coated with an amorphous carbon material 3, the coating amount is difficult to be controlled and uniformly applied, and therefore the coating amount is restricted in general. Therefore, the carbon material 20 of such multi-layer structure exhibits properties derived from the graphite. This means that there is a limit in improving the output.

Simply mixing the graphite material 1 and the second carbon material 2 merely allows the graphite material 1 and the second carbon material 2 to be brought into contact with each other as shown in FIG. 3. In such a case, the properties of the carbon material having a higher mixing ratio become predominant, and no synergistic effect of the graphite material 1 and the second carbon material 2 can be obtained.

The degree of graphitization of the composite negative electrode active material 10 of the present invention is dependent on the mixing ratio of the graphite material 1 and the second carbon material 2. In an X-ray chart obtained by powder X-ray diffractometry, a peak derived from the graphite material 1 is predominantly observed.

The value of the specific surface area of the composite negative electrode active material 10 is preferably 1.0 m²/g or more and 5.0 m²/g or less, and particularly preferably 1.5 m²/g or more and 3.0 m²/g or less. If the value of the specific surface area is less than 1.0 m²/g, a sufficient reaction area cannot be ensured, making it difficult to improve the output-input characteristics. On the other hand, if the value of the specific surface area exceeds 5.0 m²/g, side reaction occurs between the composite negative electrode active material and the non-aqueous electrolyte, causing the life characteristics to be reduced.

The specific surface area can be determined by using a method commonly known as BET method from the amount of nitrogen gas adsorbed to the composite negative electrode active material.

The mean particle size of the composite negative electrode active material 10 is preferably approximately 5 μm to 15 μm. The maximum particle size thereof is preferably approximately 30 μm. It is preferable that in the composite negative electrode active material 10 of the present invention, the difference between the particle size of the graphite material 1 and that of the second carbon material 2 is small.

The mean particle size can be measured, for example, by using a particle size distribution analyzer HELOS system available from Japan Laser Corp., a laser diffraction particle size distribution analyzer SALD series available from Shimadzu Corporation, or the like.

In order to obtain a negative electrode active material more excellent in capacity, high output-input characteristics, and life characteristics, the mixing ratio of the graphite material and the second carbon material is critical. It is preferable that the amount of the graphite material 1 which determines the capacity density mainly is set to 60% by mass to 90% by mass. An amount of the graphite material 1 of less than 60% by mass results in a remarkably low capacity density of the negative electrode. An amount of the graphite material 1 exceeding 90% by mass results in a predominance of the properties of the graphite material 1 in the composite negative electrode active material. Therefore, there is a limit in the improvement of the output-input characteristics. A more preferred amount of the graphite material 1 is 70% by mass to 80% by mass because this can most readily provide a synergistic effect of the graphite material 1 and the second carbon material 2.

It is further preferable that the fused matter of the graphite material 1 and the second carbon material 2 is coated with the amorphous carbon material 3. FIG. 4 shows a composite negative electrode active material according to another embodiment of the present invention. In FIG. 4, the same component as in FIG. 1 is denoted by the same reference number.

A composite negative electrode active material 40 in FIG. 4 includes a fused matter of the graphite material 1 and the second carbon material 2, and the amorphous carbon material 3 coating the surface of the fused matter. The amorphous carbon material 3 may coat the entire surface of the fused matter or alternatively may coat a part of the surface of the fused matter.

Coating the fused matter of the graphite material 1 and the second carbon material 2 with the amorphous carbon material 3 increases the effect obtained by fusing the graphite material 1 and the second carbon material 2. Moreover, coating the surface of the fused matter with the amorphous carbon material 3 increases the effect of absorbing and desorbing lithium ions. As a result, the output-input characteristics and life characteristics can be further improved.

It should be noted that at least a part of the amorphous carbon material 3 serving as a coating layer also has an ability of absorbing and desorbing lithium.

The ratio of the amorphous carbon material 3 to a total of the graphite material 1, the second carbon material 2, and the amorphous carbon material 3 is preferably less than 10% by mass, and more preferably 5% by mass or more and less than 10% by mass. If the ratio of the amorphous carbon material 3 is 10% by mass or more, it becomes difficult to obtain the synergistic effect obtained by fusing the graphite material 1 and the second carbon material 2. Further, because of the predominance of the properties of the amorphous carbon material 3, the irreversible capacity is increased or the initial charge-discharge efficiency of the negative electrode active material is reduced. As a result, the battery capacity may be reduced.

It should be noted if the ratio of the amorphous carbon material 3 is less than 5% by mass, the fused matter of the graphite material 1 and the second carbon material 2 will have a portion that is not coated with the amorphous carbon material 3, and therefore it may be difficult to obtain a further improvement of the effect obtained by fusing the graphite material 1 and the second carbon material 2.

It should be noted that the mean particle size of the composite negative electrode active material 40 of FIG. 4 is preferably 5 to 20 μm.

The composite negative electrode active material as shown in FIG. 1 can be prepared, for example, by a method including the steps of:

(a) mixing a graphite material and a graphitizable carbon material undergoing graphitization (a second carbon material) in a predetermined ratio to give a mixed carbon material;

(b) heating the mixed carbon material at 700° C. to 1300° C. to give a fused matter of the graphite material and the graphitizable carbon material undergoing graphitization; and

(c) crushing the fused matter.

As the graphite material, it is possible to use natural graphite or artificial graphite without any particular limitation.

The artificial graphite is exemplified, for example, by a graphite material obtained by heating coke at 2500° C. to 3000° C. The coke can be prepared by carbonizing a precursor such as graphitizable anisotropic pitch or mesophase pitch.

The graphite material has a structure in which the arrangement of a graphite hexagonal network plane structure is regularly grown. The degree of graphitization of the graphite material is defined, for example, by information obtained by powder X-ray diffractometry, such as a plane spacing d₀₀₂ of (002) plane, a crystallite thickness L_{c} along c axis, and a crystallite thickness Lₐ along a axis.

The value of d₀₀₂ of the graphite material is preferably 0.335 nm to 0.336 nm; and the values of L_{c} and Lₐ are preferably 100 nm or more.

As a physical property value other than the degree of graphitization, the value of specific surface area is critical. The specific surface area of the graphite material to be used is preferably 1.0 m²/g or more and 5.0 m²/g or less. The specific surface area can be measured by a BET method.

The particle shape of the graphite material is preferably spherical, ellipsoidal or massive. The mean particle size of the graphite material is preferably approximately 5 μm to 15 μm, and the maximum particle size thereof is desirably approximately 30 μm.

The mean particle size of the graphite material can be measured, for example, by using a particle size distribution analyzer HELOS system available from Japan Laser Corp., a laser diffraction particle size distribution analyzer SALD series available from Shimadzu Corporation, or the like.

The capacity density capable of charging and discharging of the graphite material is usually within a range from 320 Ah/kg to 350 Ah/kg in a single-electrode evaluation using metallic lithium as a counter electrode. It should be noted that the theoretical capacity density of the graphite material is, for example, 372 Ah/kg when the composition of the graphite material with lithium incorporated therein is expressed by LiC₆.

The graphitizable carbon material undergoing graphitization (the second carbon material) refers to, for example, a partially graphitized carbon material obtained by heating a predetermined carbon material such as coke at a predetermined temperature. In other words, the second carbon material mainly has a turbostratic structure, but part of the material has a graphite hexagonal network plane structure. In the second carbon material, as in the case of the graphite material, lithium is absorbed or desorbed mainly through intercalation reaction. However, in the second carbon material, since the graphite layer structure is under development, the amount of lithium that can be intercalated is restricted. For this reason, the capacity density of the second carbon material is far short of the theoretical capacity density of graphite (372 Ah/kg), and is approximately 170 Ah/kg to 280 Ah/kg.

In the second carbon material, the value of d₀₀₂ serving as an index of the degree of graphitization is preferably 0.338 nm to 0.342 nm, and the value of L_{c} is preferably 50 nm or less. In addition, for accurate evaluation of the degree of graphitization, in the case of using CuKα radiation as a target, the intensity ratio I(101)/I(100) of a 101 diffraction peak observed in the vicinity of 2θ=44 degrees to a 100 diffraction peak observed in the vicinity of 2θ=42 degrees is critical. In the second carbon material, the ratio is preferably 0<I(101)/I(100)<1.0, and more preferably 0.5<I(101)/I(100)<1.0. In the graphite material, the peak intensity ratio I(101)/I(100) is 1.5 or more.

The value of specific surface area of the second carbon material is preferably 1.0 m²/g or more and 5.0 m²/g or less, and more preferably 1.5 m²/g or more and 3.0 m²/g or less.

The particle shape of the second carbon material, as in the case of the graphite material, is preferably spherical, ellipsoidal or massive. The mean particle size of the second carbon material is preferably approximately 5 μm to 15 μm, and the maximum particle size thereof is desirably approximately 30 μm.

In the step (a), the ratio of the graphite material to a total of the graphite material and the second carbon material is preferably 60% by mass to 90% by mass, and more preferably 70% by mass to 80% by mass. The reason for this is the same as described above.

Further, as described above, in the conventional carbon material of multi-layer structure, the ratio of the coating layer is restricted, and the amount thereof is extremely small. In contrast, in the present invention, the fusion ratio of the graphite material and the second carbon material can be controlled as desired.

In the foregoing step (b), a heat treatment temperature of lower than 700° C. is insufficient as a sintering temperature, and therefore the graphite material and the second carbon material cannot be fused together. A heat treatment temperature of higher than 1300° C. allows the graphitization of the second carbon material to proceed to a higher degree, resulting in reduced high output-input characteristics of a composite negative electrode active material to be prepared.

In the step (c), it is preferable to classify the crushed matter. The mean particle size of a composite negative electrode active material thus prepared is preferably 5 μm to 15 μm, and the maximum particle size is preferably approximately 30 μm.

The mixing of a graphite material and a second carbon material in the foregoing step (a) and the crushing of the fused matter in the step (c) can be carried out in the manner well known in the art.

The second carbon material can be prepared using various carbon materials. Above all, it is preferable to prepare the second carbon material by heating a graphitizable carbon material such as coke at 1400° C. to 2200° C. If the heat treatment temperature is lower than 1400° C., the graphitization of the graphitizable carbon material proceeds insufficiently, and therefore a sufficient capacity may not be obtained. If the heat treatment temperature is higher than 2200° C., the graphitization of the graphitizable carbon material may proceed excessively. As a result, the output-input characteristics of a composite negative electrode active material prepared by fusing such a second carbon material and a graphite material may be reduced.

It should be noted that if the graphitizable carbon material is heated at a temperature lower than 1400° C., the second carbon material cannot be obtained.

The graphitizable carbon material can be prepared by heating a carbon precursor at a predetermined temperature of, for example, 700° C. to 12000C. The carbon precursor is exemplified by, although not limited to, the following aromatic compounds, for example, a condensed polycyclic aromatic hydrocarbon having two or more rings, such as naphthalene, azulene, indacene, fluorene, phenanthrene, anthracene, triphenylene, pyrene, chrysene, naphthacene, picene, perylene, pentaphene, and pentacene; a condensed heterocyclic compound consisting of a three or more membered heterocyclic ring and an aromatic hydrocarbon condensed together, such as indole, isoindole, quinoline, isoquinoline, quinoxane, phthalazine, carbazole, acridine, phenazine, and phenanthrozine; an aromatic oil, such as anthracene oil, decrystallized anthracene oil, naphthalene oil, methylnaphthalene oil, tar, creosote oil, ethylene bottom oil, carbolic oil, and solvent naphtha; and a petroleum- or coal-based pitch.

The aromatic compounds as listed above may have a substituent that exerts no adverse influence on the below-described cross-linking reaction, such as an alkyl group, hydroxyl group, an alkoxy group, and a carboxyl group. The aromatic compounds as listed above may be used alone or in combination of two or more. Moreover, the above-described aromatic compounds may be used in combination with a ring assembly compound, such as biphenyl and binaphthalene.

It is preferable to add a cross-linking agent and a graphitizing catalyst to the carbon precursor as listed above and heat the resultant mixture, so that cross-links are formed in the carbon precursor. Specifically, the mixture of the carbon precursor, the cross-linking agent, and the graphitizing catalyst is stirred, for example, at 80° C. to 400° C. for one minute or longer, preferably for five minutes or longer so as to be uniformly mixed, whereby the carbon precursor with increased molecular weight can be obtained. Thereafter, the carbon precursor is carbonized, for example, at a temperature ranging from 700° C. to 1200° C., and crushed so as to have a predetermined median particle size, whereby a graphitizable carbon material can be obtained. In such a manner, the molecular weight of the carbon precursor can be increased, and the carbonization yield of the graphitizable carbon material can enhanced.

For example, in the case where the aromatic compounds capable of undergoing electrophilic substitution reaction are used as the carbon precursor, it is possible to use, as the cross-linking agent, various bifunctional compounds that can form cross-links in at least one of the aromatic compounds. Specifically, examples thereof include aromatic dimethylene halide, such as xylene dichloride; aromatic dimethanol, such as xylene glycol; aromatic dicarbonyl halide, such as terephthaloyl chloride, isophthaloyl chloride, phthaloyl chloride, and 2,6-naphthalenedicarbonyl chloride; aromatic aldehyde, such as benzaldehyde, p-hydroxybenzaldehyde, p-methoxybenzaldehyde, 2,5-dihydroxybenzaldehyde, benzaldehyde dimethyl acetanol, telephthalaldehyde, isophthalaldehyde, and salicylaldehyde. These cross-linking agents may be used alone or in combination of two or more.

The amount of cross-linking agent to be used can be selected from a wide range according to the characteristics of the aromatic compounds capable of undergoing electrophilic substitution reaction. For example, the amount of cross-linking agent to be used per 1 mole of condensed polycyclic aromatic hydrocarbon or 1 mole of condensed heterocyclic compound is, for example, 0.1 to 5 moles, and preferably approximately 0.5 to 3 moles. In a mixture of aromatic compounds such as pitches, the added amount of cross-linking agent is, for example, 0.01 to 5 moles per 1 mole (mean molecular weight) of the mixture, and preferably 0.05 to 3 moles.

The cross-linking reaction using the above-described cross-linking agent is usually allowed to proceed in the presence of acid catalyst. As the acid catalyst, it is possible to use, for example, a commonly used acid, such as Lewis acid and Broensted acid. Examples of the Lewis acid include, for example, ZnCl₂, BF₃, AlCl₃, SnCl₄, and TiCl₄. Examples of the Broensted acid include, for example, an organic acid, such as p-toluenesulfonic acid, fluoromethanesulfonic acid, and xylene sulfonic acid; a mineral acid, such as hydrochloric acid, sulfuric acid, and nitric acid. As the acid catalyst, the Broensted acid is preferable.

The amount of acid catalyst to be used can be selected as needed according to the reaction conditions, the reactivity of the above-described aromatic compounds capable of undergoing electrophilic substitution reaction and the like. For example, the amount of acid catalyst to be used per 1 mole of the above-described cross-linking agent is 0.01 to 10 mole equivalents, and preferably 0.5 to 3 mole equivalents.

The cross-linking reaction may be allowed to proceed in a predetermined solvent, but preferably allowed to proceed without the presence of a solvent. The cross-linking reaction is allowed to proceed at a temperature, for example, of 80 to 400° C., and preferably of 100 to 350° C. The cross-linking reaction can be allowed to proceed in an inert gas atmosphere such as of nitrogen, helium, and argon, or alternatively in an oxidizing atmosphere such as of air and oxygen. After the cross-linking reaction, the obtained carbon precursor is cooled to room temperature and can be collected as a solid resin.

As the graphitizing catalyst, it is possible to use, for example, boron simple substance or a boron compound. The boron compound may be any compound as long as the compound contains boron atom. It is exemplified by boric acid, boron oxide, boron carbide, boron chloride, sodium borate, potassium borate, copper borate, nickel borate, and the like.

The graphitizing catalyst is added in an amount, per 100 parts by mass of the carbon precursor, for example, of 0.1 to 20 parts by mass, and preferably 1 to 10 parts by mass.

In the foregoing step (a), it is preferable to add a heavy oil that functions as a binder to the mixed carbon material of the graphite material and the second carbon material. The further addition of the heavy oil can further improve the sinterability between the graphite material and the second carbon material. Eventually, as shown in FIG. 4, the obtained sintered matter will be coated with an amorphous carbon material derived from the heavy oil. As described above, the sinterability of sintered matter is improved and the sintered matter is covered with the amorphous carbon material, making it possible to improve the output characteristics and the life characteristics of the composite negative electrode active material.

As the heavy oil, for example, a molten pitch is used. It should be noted that the carbon material obtained by heating the heavy oil at a temperature of 700 to 1300° C. is amorphous.

The amount of heavy oil to be added is preferably less than 10 parts by mass per 100 parts by mass of the mixed carbon material. If the amount of the heavy oil is 10 parts by mass or more, it becomes difficult to make the synergistic effect obtained by fusing the graphite material 1 and the second carbon material effective. Further, because of the predominance of the properties of the amorphous carbon material derived from the heavy oil, the irreversible capacity is increased or the initial charge-discharge efficiency of the negative electrode active material is reduced.

In the case of adding no heavy oil, although the sinterability is slightly lower than in the case of adding the heavy oil, the graphite material and the second carbon material are sufficiently fused. Specifically, in the case of adding no heavy oil, most part of the second carbon material remains as a solid carbonized matter, but a part of it vaporizes. A part of the vaporized component is chemically vapor-deposited on the surface of the graphite material and the second carbon material, and functions as a binder. For this reason, the graphite material and the second carbon material can be fused together.

Prior to the heat treatment, it is further preferable to form the mixture of the mixed carbon material and the heavy oil into a molded body. This can further improve the sinterability between the graphite material and the second carbon material.

The composite negative electrode active material of the present invention can be used as a negative electrode active material for a non-aqueous electrolyte secondary battery. FIG. 5 shows a non-aqueous electrolyte secondary battery according to one embodiment of the present invention.

A non-aqueous electrolyte secondary battery 50 in FIG. 5 includes a positive electrode plate 51, a negative electrode plate 52, a separator 53 interposed between the positive electrode plate 51 and the negative electrode plate 52, and a non-aqueous electrolyte (not shown). The positive electrode plate, the separator, and the negative electrode plate constitute a wound electrode assembly.

The positive electrode plate 51 includes, for example, a positive electrode core material and a positive electrode material mixture layer carried thereon. The negative electrode plate 52 includes, for example, a negative electrode core material and a negative electrode material mixture layer carried thereon.

One end of a positive electrode lead 54 is connected to the positive electrode plate 51, and the other end of the positive electrode lead 54 is connected to the back face of a sealing plate 59 electrically connected to a positive electrode terminal 60. One end of a negative electrode lead 55 is connected to a negative electrode plate 52, and the other end of the negative electrode lead 55 is connected to the bottom of a battery case 58. In the upper portion of the electrode assembly, an upper insulating plate 56 is disposed; and in the lower portion, a lower insulating plate 57 is disposed.

The negative electrode material mixture layer includes the composite negative electrode active material of the present invention, a binder, and as needed, a conductive material. The positive electrode material mixture layer includes a positive electrode active material, a binder and a conductive material.

For the positive electrode core material, the negative electrode core material, the conductive material, the binder, and the separator, it is possible to use ones known in the art without any particular limitation.

The non-aqueous electrolyte includes, for example, a non-aqueous solvent and a solute dissolved therein. For the non-aqueous solvent and the solute, any material known in the art may be used.

As the positive electrode active material, it is possible to use, for example, a lithium-containing composite oxide. As the lithium-containing composite oxide, it is possible to use the one known in the art without any particular limitation, which is exemplified by LiCoO₂, LiNiO₂, LiMn₂O₄ having a spinel structure, and the like.

In order to improve the cycle life characteristics, a transition metal contained in the lithium-containing composite oxide may be partially replaced with other element(s). For example, a composite oxide in which Ni element in LiNiO₂ is partially replaced with Co or other element(s) (Al, Mn, Ti, etc.) can be preferably used.

It is also possible to use, as the positive electrode active material, a material that does not contain lithium in the process of forming the positive electrode but is formed into a lithium-containing composite oxide by undergoing a subsequent process for allowing lithium to be contained.

In the case where the positive electrode material mixture layer is carried on both faces of the positive electrode core material, the total thickness of the two positive electrode material mixture layers is preferably approximately 50 μm to 100 μm. In the case where the negative electrode material mixture layer is carried on both faces of the negative electrode core material, the total thickness of the two negative electrode material mixture layers is preferably approximately 60 μm to 130 μm.

The non-aqueous electrolyte secondary battery can fabricated, for example, in the following manner.

The positive electrode plate and the negative electrode plate, and the separator disposed between the positive electrode plate and the negative electrode plate as described above are wound to give an electrode assembly. The electrode assembly is housed in a battery case, and then the non-aqueous electrolyte is injected into the battery case. Subsequently, the opening of the battery case is hermetically closed with a sealing plate, whereby the non-aqueous electrolyte secondary battery can be obtained.

The shape of the non-aqueous electrolyte secondary battery may be cylindrical or prismatic. In a prismatic battery, a flat electrode assembly may be used or alternatively, a layered electrode assembly may be used. The flat electrode assembly can be formed by, for example, winding the positive electrode plate, the separator, and the negative electrode plate in the form of an elliptic cylinder, and then compressing the obtained wounded matter so as to have an approximate square cross-sectional face. The layered electrode assembly can be formed by, for example, layering plural positive and negative electrode plates with the separator interposed therebetween.

### EXAMPLES

Although the present invention is described below with reference to Examples, the present invention is not limited to these Examples.

### Example 1

### Formation of Positive Electrode Plate

As the positive electrode active material, a lithium nickel composite oxide represented by the compositional formula LiNi_{0.8}Co_{0.15}Al_{0.05}O₂ was used. This positive electrode active material was prepared in the following manner.

To a predetermined concentration of aqueous NiSO₄ solution, Co sulfate and Al sulfate were added at a predetermined rate to prepare a saturated aqueous solution. While this saturated aqueous solution was stirred, an aqueous alkali solution in which sodium hydroxide was dissolved was slowly dropped to the saturated aqueous solution to neutralize it. In such a manner, a ternary nickel hydroxide Ni_{0.8}Co_{0.15}Al_{0.05}(OH)₂ was produced by a coprecipitation method. The obtained precipitate was collected by filtration, washed with water, and then dried at 80° C., to give a nickel hydroxide containing Co and Al, Ni_{0.8}Co_{0.15}Al_{0.05}(OH)₂. The mean particle size of the obtained nickel hydroxide was approximately 10 μm.

Subsequently, the nickel hydroxide containing Co and Al and a lithium hydroxide monohydrate were mixed such that the total number of Ni, Co and Al atoms became equal to the number of Li atoms. The resultant mixture was heated at 800° C. in dry air for 10 hours, to give an intended lithium nickel composite oxide LiNi_{0.8}Co_{0.15}Al_{0.05}O₂. The lithium nickel composite oxide thus obtained was analyzed by powder X-ray diffractometry. The results found that the lithium nickel composite oxide thus obtained had a single-phase hexagonal layer structure, and Co and Al were dissolved in the lithium nickel composite oxide.

The lithium nickel composite oxide was crushed and classified, to give a positive electrode active material powder. The mean particle size of the positive electrode active material powder was 9.5 μm.

100 parts by mass of the positive electrode active material and 5 parts by mass of acetylene black serving as the conductive material were mixed. To the resultant mixture, an N-methyl-2-pyrrolidone (NMP) solution of polyvinylidene fluoride (PVdF) serving as the binder was added, and then mixed, to prepare a positive electrode material mixture paste. The amount of added PVdF was 5 parts by mass per 100 parts by mass of the positive electrode active material. Subsequently, the paste thus obtained was applied onto both faces of an aluminum foil serving as the positive electrode core material, dried, and then rolled, to form a positive electrode plate having a thickness of 0.075 mm and a length of 3400 mm. In the positive electrode plate thus obtained, the width of the material mixture layer was 100 mm, and the length thereof was 3400 mm. The total thickness of the two positive electrode material mixture layers carried on both faces of the positive electrode core material was 55 μm.

### (Formation of Negative Electrode Plate)

The second carbon material was prepared in the following manner.

100 parts by mass of pitch (product type: AR24Z available from Mitsubishi Gas Chemical Company, Inc., softening point: 293.9° C.), 5 parts by mass of para-xylene glycol serving as the cross-linking agent, and 5 parts by mass of boric acid serving as the catalyst were mixed. The temperature of the resultant mixture was raised to 300° C. under normal pressure to melt the mixture, and the mixture was kept as it was for 2 hours. The polymerized pitch thus obtained was heated at 800° C. for 1 hour in argon atmosphere, thereby to give a graphitizable carbon material.

The graphitizable carbon material thus obtained was crushed so as to have a median particle size of 10 μm. The crushed graphitizable carbon material was heated at 2000° C. in argon atmosphere to give a second carbon material.

The degree of graphitization of the second carbon material thus obtained was analyzed by powder X-ray diffractometry. The results showed that the d₀₀₂ was 0.340 nm, and the ratio I(101)/I(100) was 0.68. The specific surface area measured by a BET method was 2.2 m²/g.

The graphite material was obtained by heating the crushed graphitizable carbon material used in the process of preparing the second carbon material, at 2800° C. in argon atmosphere. The d₀₀₂ of the obtained graphite material was 0.335 nm, and the ratio I(101)/I(100) was 1.90. The specific surface area was 1.9 m²/g.

The negative electrode active material was prepared in the following manner.

80 parts by mass of the obtained graphite material and 20 parts by mass of the second carbon material were mixed. To this mixture, 5 parts by mass of heavy oil prepared by melting isotropic pitch (available from Osaka Gas Chemicals Co., Ltd., softening point: 280° C.) at 300° C. was further added. These were mixed, and subsequently, the resultant mixture was heated at 1000° C. in argon atmosphere, to give a composite carbon material. In the composite carbon material thus obtained, the graphite material and the second carbon material were sintered together. The composite carbon material was crushed and classified, whereby a composite negative electrode active material was obtained. The mean particle size of the composite negative electrode active material was approximately 9 μm. In the composite negative electrode active material thus obtained, a part of the surface of the fused matter of the graphite material and the second carbon material was coated with an amorphous carbon material.

The negative electrode plate was formed in almost the same manner as the positive electrode plate.

100 parts by mass of the composite negative electrode active material powder and an NMP solution of PVdF were mixed to prepare a negative electrode material mixture paste. The adding amount of PVdF was 8 parts by mass per 100 parts by mass of the negative electrode active material.

Subsequently, the paste thus obtained was applied onto both faces of a copper foil serving as the negative electrode core material, dried, and then rolled, to form a negative electrode plate having a thickness of 0.078 mm and a length of 3510 mm. In the negative electrode plate thus obtained, the width of the material mixture layer was 105 mm, and the length thereof was 3510 mm. The total thickness of the negative electrode material mixture layers carried on both faces of the negative electrode core material was 68 μm.

### (Fabrication of Battery)

Between the positive electrode plate and the negative electrode plate obtained as described above, a separator made of a microporous polyethylene film having a thickness of 0.020 mm and a width of 108 mm was disposed, and the positive electrode plate, the negative electrode plate, and the separator were wound spirally, to form a cylindrical electrode plate assembly. The electrode plate assembly thus obtained was housed in a battery case having a diameter of 32 mm and a height of 120 mm. One end of a positive electrode lead was connected to the positive electrode plate, and the other end of the positive electrode lead was connected to the back face of a sealing plate electrically connected to a positive electrode terminal. One end of a negative electrode lead was connected to the negative electrode plate, and the other end of the negative electrode lead was connected to the bottom of the battery case. A non-aqueous electrolyte was injected into the battery case, and the opening of the battery case was sealed, whereby Battery 1 was obtained.

The non-aqueous electrolyte was prepared by dissolving LiPF₆ at a concentration of 1 mol/L in a solvent in which ethylene carbonate, dimethyl carbonate, ethyl methyl carbonate were mixed in a volume ratio of 3:4:3.

The fabricated battery was designed such that the capacity density of the negative electrode in a full-charged state was approximately 300 Ah/kg.

### Example 2

In the process of preparing the composite carbon material, the mixed carbon material of 80 parts by mass of the graphite material and 20 parts by mass of the second carbon material was heated at 1200° C. in argon atmosphere without adding a heavy oil. The composite carbon material thus obtained was a solid matter in which the graphite material and the second carbon material were aggregated and sintered together. The composite carbon material was crushed and classified, whereby a composite negative electrode active material having a mean particle size of approximately 9 μm was obtained. Battery 2 was fabricated in the same manner as in Example 1 except that this composite negative electrode active material was used.

### Comparative Example 1

Comparative Battery 1 was fabricated in the same manner as in Example 1 except that the graphite material was used as the negative electrode active material.

### Comparative Example 2

Comparative Battery 2 was fabricated in the same manner as in Example 1 except that the second carbon material was used as the negative electrode active material.

### Comparative Example 3

Comparative Battery 3 was fabricated in the same manner as in Example 1 except that a non-graphitizable carbon material was used as the negative electrode active material.

The non-graphitizable carbon material was prepared in the following manner.

Coal-based coal tar pitch having a softening point of 280° C. was crushed so as to have a medium particle size of approximately 30 μm. The crushed pitch was subjected to oxidation at 300° C. for 3 hours in air atmosphere, to give a first product. The first product was crushed again so as to have a medium particle size of approximately 5 μm, and subjected to oxidation at 300° C. for 2 hours, to give a second product. Thereafter, the second product was heated at 1050° C. in argon gas atmosphere, to give a third product. The third product was crushed and classified, whereby the non-graphitizable carbon material having a mean particle size of approximately 6 μm was obtained.

The non-graphitizable carbon material thus obtained was analyzed by powder X-ray diffractometry. As the result, the d₀₀₂ was 0.380 nm, and a 101 diffraction peak to be observed in the vicinity of 2θ=44 degrees did not appear. This indicated, therefore, that the non-graphitizable carbon material thus obtained had little or no graphite layer structure.

### Comparative Example 4

Comparative Battery 4 was fabricated in the same manner as in Example 1 except that a carbon material of multi-layer structure was used as the negative electrode active material.

The carbon material of multi-layer structure was prepared in the following manner.

95 parts by mass of the graphite material prepared in Example 1 and 5 parts by mass of the isotropic pitch (available from Osaka Gas Chemicals Co., Ltd., softening point: 280° C.) that was melted at 300° C. was sufficiently mixed. The mixture was heated at 1000° C. in argon atmosphere. The product thus obtained was crushed and classified, whereby a carbon material of multi-layer structure in which the surface of the graphite material was coated with an amorphous carbon material was obtained. The mean particle size of the carbon material of multi-layer structure was approximately 10 μm. It should be noted that the maximum amount of the amorphous carbon material that can be formed on the surface of the graphite particle is approximately 5% by mass of the carbon material of multi-layer structure. If the graphite material and the molten pitch are mixed in a ratio higher than this, the molten pitch tends to be carbonized into carbonaceous particles rather than being formed into a coating layer.

### Comparative Example 5

The graphite material and the second carbon material prepared in Example 1 were mixed in a mass ratio of 80:20. Comparative Battery 5 was fabricated in the same manner as in Example 1 except that the mixture thus obtained was used as the negative electrode active material.

### [Evaluation]

### (Measurement of Initial Capacity)

Each battery of Batteries 1 to 2 and Comparative Batteries 1 to 5 was charged at a current of 2.7 A in 25° C. environment until the battery voltage reached 4.1 V. The battery after charge was discharged at a current of 2.7 A until the battery voltage dropped to 2.5 V. Such charge-discharge operation was performed 3 cycles in total. The discharge capacity at the 3rd cycle was referred to as an initial capacity. The results are shown in Table 1.

### (Current-Voltage Characteristic Test)

After the measurement of the initial capacity, in order to measure the output value of the foregoing batteries and comparative batteries, the current-voltage characteristic test was performed by following the procedures below.

First, each battery was charged at a predetermined current value in 25° C. environment so as to be in a 50% charged state (SOC). With respect to the battery after charge, a discharge pulse and a charge pulse were applied repeatedly for 10 seconds each at a current of ranging from 1 C hour rate to the maximum of 10 C hour rate.

The battery voltage after the passage of 10 seconds from the start of application of a discharge pulse at a discharge current [C] of a predetermined hour rate was measured and the measured values were plotted versus the current values. The example of the plotting is shown in FIG. 6. In FIG. 6, plotted points of voltage are linearly approximated to a line by a least squares method, and the line is extrapolated to a discharge lower limit voltage of 2.5 V, to determine a predicted current value (A) at 2.5 V. An output (W) was calculated by multiplying the predicted current value (A) by 2.5 (V). The results are shown in Table 1.

(Measurement of Capacity after Cycling)

The battery having been subjected to the charge-discharge characteristic test was charged again at a current of 2.7 A until the battery voltage reached 4.1 V, and then discharged at a current of 2.7 A until the battery voltage dropped to 2.5 V. Such charge-discharge operation was performed 50 cycles in total, and the discharge capacity at the 50th cycle was measured. The discharge capacity obtained in this measurement, which is referred to as a capacity after cycling, is shown in Table 1.

TABLE 1

| | Initial | Capacity | |
|---|---|---|---|
| | capacity | after cycling | Output value |
| | (Ah) | (Ah) | (W) |
| Battery 1 | 8.0 | 7.9 | 650 |
| Battery 2 | 8.0 | 7.8 | 640 |
| Comparative Battery 1 | 8.1 | 7.6 | 580 |
| Comparative Battery 2 | 7.7 | 5.8 | 600 |
| Comparative Battery 3 | 6.9 | 6.7 | 620 |
| Comparative Battery 4 | 7.8 | 7.5 | 570 |
| Comparative Battery 5 | 7.7 | 7.4 | 580 |

In Batteries 1 and 2, the initial capacity and the capacity after cycling were both high, and the output value was also large.

In contrast, in Comparative Battery 1, the initial capacity and the capacity after cycling were high, but the output value was small. The negative electrode of Comparative Battery 1 included the graphite material having a high crystallinity only as the negative electrode active material. Presumably, the slow lithium ions diffusibility in the graphite material resulted in the small output value.

In Comparative Battery 2, the capacity after cycling was noticeably small. Comparative Battery 2 was disassembled after the measurement of the capacity after cycling to check the negative electrode plate, and as the result, the deposition of metallic lithium thereon was observed. The negative electrode of Comparative Battery 2 included the second carbon material only as the negative electrode active material. This second carbon material is capable of intercalating lithium ions, but the amount of lithium ions to be intercalated is small, making it impossible for the negative electrode to maintain the design capacity of 300 Ah/kg. Presumably, this caused metallic lithium to be deposited on the surface of the negative electrode during charge, accelerating the deterioration of the battery.

Comparative Battery 3 demonstrated a considerably small initial capacity. The non-graphitizable carbon material used as the negative electrode active material has a large irreversible capacity. Presumably, this caused a capacity loss in the positive electrode, resulted in a reduced battery capacity.

In Comparative Battery 4, as in the case of Comparative Battery 1, the output value was small. The carbon material of multi-layer structure used as the negative electrode active material was mainly composed of the graphite material and the amount of the coating layer was small. Presumably, little or no effect of the amorphous carbon material constituting the coating layer was obtained, and the coating layer made little or no contribution to the improvement of the output value.

Also in Comparative Battery 5, the output value was small. The negative electrode active material used in Comparative Battery 5 was a mixture prepared merely by mixing the graphite material and the second carbon material. This indicates that the merely mixing of the graphite material and the second carbon material cannot produce a synergistic effect of improving both the capacity and the output value.

The foregoing results indicate that using a composite carbon material prepared by fusing a graphite material and a second carbon material as a negative electrode active material makes it possible to provide a non-aqueous electrolyte secondary battery having a high capacity and being excellent in output characteristics and life characteristics.

### Example 3

For the positive electrode active material, a lithium nickel composite oxide represented by the compositional formula LiNi_{0.4}Co_{0.3}Mn_{0.3}O₂ was used. This lithium nickel composite oxide was prepared in the following manner.

To a predetermined concentration of aqueous NiSO₄ solution, Co sulfate and Mn sulfate were added at a predetermined ratio to prepare a saturated aqueous solution. While this saturated aqueous solution was stirred, an aqueous alkali solution in which sodium hydroxide was dissolved was slowly dropped to neutralize the saturated aqueous solution. In such a manner, a ternary nickel hydroxide Ni_{0.4}Co_{0.3}Mn_{0.3}(OH)₂ was produced by a coprecipitation method. The obtained precipitate was collected by filtration, washed with water, and then dried at 80° C., to give a nickel hydroxide containing Co and Mn, Ni_{0.4}Co_{0.3}Mn_{0.3}(OH)₂.

Subsequently, the nickel hydroxide containing Co and Mn and a lithium hydroxide monohydrate were mixed such that the total number of Ni, Co and Mn atoms became equivalent to the number of Li atoms. This mixture was heated at 850° C. for 10 hours in dry air, to give an intended lithium nickel composite oxide LiNi_{0.4}Co_{0.3}Mn_{0.3}O₂. The lithium nickel composite oxide thus obtained was analyzed by powder X-ray diffractometry. The results found that the lithium nickel composite oxide thus obtained had a single-phase hexagonal layer structure, and Co and Mn were dissolved in the lithium nickel composite oxide.

The lithium nickel composite oxide was crushed and classified, to give a positive electrode active material powder. The mean particle size of the positive electrode active material particles was 11.2 μm.

This positive active material was used, and a positive electrode plate was fabricated in the same manner as in Example 1.

100 parts by mass of pitch (product type: AR24Z available from Mitsubishi Gas Chemical Company, Inc., softening point: 293.9° C.), 5 parts by mass of para-xylene glycol, and 5 parts by mass of boric acid were mixed. The temperature of the resultant mixture was raised to 300° C. under normal pressure to melt the mixture, and the mixture was held in a molten state for 2 hours. The polymerized pitch thus obtained was heated at 800° C. for 1 hour in argon atmosphere, thereby to give a graphitizable carbon material.

Subsequently, the graphitizable carbon material thus obtained was crushed so as to have a median particle size of 10 μm, and then heated at 1800° C. in nitrogen atmosphere, thereby to give a second carbon material. The degree of graphitization of the second carbon material thus obtained was analyzed by powder X-ray diffractometry. The results showed that the d₀₀₂ was 0.341 nm, and the ratio I(101)/I(100) was 0.60. The specific surface area was 2.5 m²/g.

As the graphite material, natural graphite (available from Kansai Coke and Chemicals Co., Ltd.) was used. The mean particle size of the graphite material was approximately 12 μm. The d₀₀₂ of the graphite material was 0.335 nm, and the I(101)/I(100) was 2.2. The specific surface area thereof was 3.0 m²/g.

The second carbon material obtained in the manner as described above and the graphite material were mixed in a ratio (mass ratio) as shown in Table 2. To the resultant mixture, 5 parts by mass of heavy oil prepared by melting isotropic pitch (available from Osaka Gas Chemicals Co., Ltd., softening point: 280° C.) at 300° C. was added and mixed. The resultant mixture was heated at 1000° C. in argon atmosphere. The product was crushed and classified, whereby composite negative electrode active materials A to F were obtained.

The composite negative electrode active materials A to F were used, and negative electrode plates A to F were fabricated in the same manner as in Example 1.

The positive electrode plates and the negative electrode plates obtained in the manner as described above were used, and Battery A to Battery F were fabricated in the same manner as in Example 1.

The capacity after cycling and the output value of these batteries were measured in the same manner as in Example except that the charge upper limit voltage was set at 4.2 V. The results are shown in Table 2.

TABLE 2

| | Ratio of | Ratio of | | |
|---|---|---|---|---|
| | graphite | carbon | Capacity | |
| | material | material | after cycling | Output value |
| | (% by mass) | (% by mass) | (Ah) | (W) |
| Battery A | 50 | 50 | 6.6 | 620 |
| Battery B | 60 | 40 | 7.5 | 620 |
| Battery C | 70 | 30 | 7.7 | 630 |
| Battery D | 80 | 20 | 7.8 | 630 |
| Battery E | 90 | 10 | 7.6 | 600 |
| Battery F | 95 | 5 | 7.6 | 550 |

The results of Table 2 show that in Battery B to Battery E, the capacity after cycling and the output value were both high.

On the other hand, in Battery A in which the ratio of the graphite material to a total of the graphite material and the second carbon material (hereinafter referred to as the ratio of graphite) was 50% by mass, the capacity after cycling was small as compared with those of other batteries. This was presumably because since the ratio of the second carbon material was high, the capacity density of the negative electrode was restricted, and the capability of reversibly intercalating lithium was exceeded.

In Battery F in which the ratio of the graphite material was 95% by mass, the output value was small as compared with those of the other batteries. This was presumably because since the ratio of the graphite material was predominantly high, the effect obtained by fusing the graphite material with the second carbon material was not exerted.

The results above indicate that the ratio of the graphite material to a total of the graphite material and the second carbon material is preferably 60% by mass to 90% by mass. The ratio of the graphite material is more preferably 70% by mass to 80% by mass because both the capacity after cycling and the output value can be further improved with this ratio.

### Example 4

The graphite material and the second carbon material were mixed, and the heavy oil was added to the resultant mixed carbon material in the same manner as in Example 1. Composite negative electrode active materials G to L were prepared in the same manner as in Example 1 except that the heat treatment temperature of the resultant mixture (the heat treatment temperature for fusion) was varied as shown in Table 3.

The composite negative electrode active materials G to L were used, and Batteries G to L were fabricated in the same manner as in Example 1. Here, Battery G and Battery L were comparative batteries.

The initial capacity and the output value of Battery G to Battery L were measured in the same manner as in Example 1. The results are shown in Table 3.

TABLE 3

| | Heat | | |
|---|---|---|---|
| | treatment | | |
| | temperature | Initial | |
| | for fusion | capacity | Output value |
| | (° C.) | (Ah) | (W) |
| Comparative Battery G | 600 | 7.7 | 600 |
| Battery H | 700 | 7.9 | 640 |
| Battery I | 900 | 8.0 | 650 |
| Battery J | 1100 | 7.8 | 645 |
| Battery K | 1300 | 7.7 | 640 |
| Comparative Battery L | 1400 | 7.7 | 590 |

Table 3 shows that in Battery H to Battery K, the initial capacity and the output value were both high, demonstrating good performance.

On the other hand, in Battery G in which the heat treatment temperature was 600° C. and Battery L in which the heat treatment temperature was 1400° C., the output value was low. When the heat treatment temperature was 600° C., presumably, the fusion of the graphite material and the second carbon material was incomplete, making it impossible to take advantage of the feature of the second carbon material, i.e., the high output-input characteristics. When the heat treatment temperature was 1400° C., presumably, the graphitization of the second carbon material itself proceeds, resulting in low output-input characteristics.

The results above indicate that the heat treatment temperature for fusing the graphite material and the second carbon material to synthesize a composite negative electrode active material should be 700° C. to 1300° C.

### Example 5

Second carbon materials M to R were prepared in the same manner as in Example 1 except that the heat treatment temperature of the graphitizable carbon material in the process of fabricating the second carbon material was varied as shown in Table 4. Batteries M to R were fabricated in the same manner as in Example 1 except that the second carbon materials M to R were used.

The initial capacity and the output value of Batteries M to R were measured in the same manner as in Example 1. The results are shown in Table 4.

TABLE 4

| | Heat | | |
|---|---|---|---|
| | treatment | Initial | |
| | temperature | capacity | Output value |
| | (° C.) | (Ah) | (W) |
| Battery M | 1300 | 7.4 | 650 |
| Battery N | 1400 | 7.7 | 650 |
| Battery O | 1700 | 7.8 | 650 |
| Battery P | 2000 | 7.9 | 640 |
| Battery Q | 2200 | 7.9 | 630 |
| Battery R | 2300 | 8.0 | 590 |

Table 4 shows that in Battery N to Battery Q, the initial capacity and the output value were both high, demonstrating good performance.

On the other hand, in Battery M in which the heat treatment temperature of the graphitizable carbon material was 1300° C., the output value was good, but the initial capacity was small. The degree of graphitization of the second carbon material obtained after heat treatment was excessively low, resulting in a small capacity density or an increased irreversible capacity. Presumably, this consequently reduced the capacity density of the prepared composite negative electrode active material.

In Battery R in which the heat treatment temperature of the graphitizable carbon material was 2300° C., the initial capacity was large, but the output value was small. The higher the heat treatment temperature of the graphitizable carbon material is, the higher the degree of graphitization of the second carbon material becomes. When the heat treatment temperature is 2300° C., the degree of graphitization of the obtained second carbon material becomes high, reducing the difference between the degree of graphitization of the second carbon material and that of the graphite material. Presumably, for this reason, the effect of improving the output-input characteristics obtained by the second carbon material cannot be sufficiently exerted. In other words, the performance of the composite negative electrode active material is almost similar to that of the graphite material alone.

The results above indicate that the heat treatment temperature of the graphitizable carbon material in the process of fabricating the second carbon material is preferably within a range from 1400° C. to 2200° C.

From the foregoing results of Examples and Comparative Examples, it is understood that by using the composite negative electrode active material of the present invention, it is possible to provide a non-aqueous electrolyte secondary battery having a high capacity and being excellent in output-input characteristics and life characteristics.

It should be noted that in the foregoing Examples, for the positive electrode active material, a lithium nickel composite oxide was used. As an alternative to this, it is possible to use a lithium manganese composite oxide, a lithium cobalt composite oxide, and the like for the positive electrode active material.

It is also possible to use an oxide that does not contain lithium for the positive electrode active material as long as it becomes capable of containing lithium by being subjected to a prior chemical or electrochemical operation.

In the foregoing Examples, as the non-aqueous solvent constituting the non-aqueous electrolyte, a mixed solvent of ethylene carbonate, dimethyl carbonate, and ethyl methyl carbonate was used. As an alternative to such a mixed solvent, it is possible to use a conventionally known solvent, such as propylene carbonate, diethyl carbonate, butylene carbonate, methyl propionate, and the like, and a solvent having durability to a redox potential of 4 V class as the non-aqueous solvent. These solvents may be used alone or in combination of two or more.

Further, as the solute, it is possible to use a conventionally known solute other than LiPF₆, such as LiBF₄, LiClO₄, and the like. These solutes also may be used alone or in combination of two or more.

### INDUSTRIAL APPLICABILITY

The non-aqueous electrolyte secondary battery including the composite negative electrode active material of the present invention is excellent in output-input characteristics and has a high capacity and a high energy density. For this reason, the non-aqueous electrolyte secondary battery including the composite negative electrode active material of the present invention can be used as a power source to assist an electric motor such as that in hybrid electric vehicles or fuel cell vehicles. Further, it is applicable as a driving power source for electric power tools, vacuum cleaners, robots, and the like, and a power source for large-size power storage apparatuses. Furthermore, such a non-aqueous electrolyte secondary battery can be utilized as a power source for so-called plug-in HEVs, which are expected to be widely used in the future.

1. A composite negative electrode active material for a non-aqueous electrolyte secondary battery comprising a fused matter of a graphite material and a graphitizable carbon material undergoing graphitization.

2. The composite negative electrode active material for a non-aqueous electrolyte secondary battery in accordance with claim 1, wherein said fused matter is coated with an amorphous carbon material.

3. The composite negative electrode active material for a non-aqueous electrolyte secondary battery in accordance with claim 1, wherein a ratio of said graphite material to a total of said graphite material and said carbon material undergoing graphitization is 60% by mass to 90% by mass.

4. A method for preparing a composite negative electrode active material for a non-aqueous electrolyte secondary battery comprising the steps of:
(a) mixing a graphite material and a graphitizable carbon material undergoing graphitization to give a mixed carbon material;
(b) heating said mixed carbon material at 700° C. to 1300° C. to give a fused matter of said graphite material and said carbon material undergoing graphitization; and
(c) crushing said fused matter.

5. The method for preparing a composite negative electrode active material for a non-aqueous electrolyte secondary battery in accordance with claim 4, wherein said carbon material undergoing graphitization is obtained by heating a graphitizable carbon material at 1400° C. to 2200° C.

6. The method for preparing a composite negative electrode active material for a non-aqueous electrolyte secondary battery in accordance with claim 4, wherein said step (a) further comprises a step of adding a heavy oil to said mixed carbon material.

7. The method for preparing a composite negative electrode active material for a non-aqueous electrolyte secondary battery in accordance with claim 4, wherein in said mixed carbon material, a ratio of said graphite material to a total of said graphite material and said carbon material undergoing graphitization is 60% by mass to 90% by mass.

8. A non-aqueous electrolyte secondary battery comprising a negative electrode including the composite negative electrode active material in accordance with claim 1, a positive electrode, a non-aqueous electrolyte, and a separator interposed between said positive electrode and said negative electrode.
